(19) United States
(12) Patent Application Publication
(10) Pub. No.: US 2014/0173469 A1
(43) Pub. Date: Jun. 19, 2014

(54) WEB PAGE CONTROL SYSTEM AND METHOD

(71) Applicants: HON HAI PRECISION INDUSTRY CO., LTD., New Taipei (TW); Fu Tai Hua Industry (Shenzhen) Co., Ltd., Shenzhen (CN)

(72) Inventor: XIAN QIAN, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/951,385

(22) Filed: Jul. 25, 2013

(30) Foreign Application Priority Data
Dec. 17, 2012 (CN) 2012105480824

(51) Int. Cl. G06F 3/0485

(52) U.S. Cl. CPC G06F 3/0485
USPC 715/760

(57) ABSTRACT

A web page control system and a web page control method for a portable touch control device provide an area dividing module, a page scrolling module, a determination module, and a page display control module. The area dividing module divides a web page into a number of areas including a bottom area and a jump area. The page scrolling module will scroll down the web page in response to a first touch operation from a user and the determination module determines when the web page has been scrolled down to the bottom area. When the web page is scrolled to the end, the page display control module performs a jump function and controls the web page to jump to the jump area unless the user indicates a command to maintain the display of the bottom area.

### BACKGROUND

1. Technical Field

The disclosure relates to touch control technology and, more particularly, to a web page control system and a web page control method adapted for the web page control system.

2. Description of Related Art

When a user browses a web page on a touch device, the user must slide content of the web page from the top to the bottom, and once the content of the bottom of the web page is displayed, the user wants to look again at other content of the web page, the user must slide the web page again, it is very inconvenient.

Therefore, what is needed is a web page control system to overcome the described shortcomings

### BRIEF DESCRIPTION OF THE DRAWINGS

FIG. 1 is a block diagram of a portable touch control device including a web page control system in accordance with an exemplary embodiment.

FIG. 2 is a block diagram of the web page control system of the portable touch control device of FIG. 1.

FIG. 3 is a flowchart of web page control method adapted for the web page control system of FIG. 1.

FIG. 4 is a schematic view of a first part of content of a web page displayed by the portable touch control device of FIG. 1.

FIG. 5 is a schematic view of a second part of content of the web page displayed by the portable touch control device of FIG. 4.

FIG. 6 is a schematic view of a third part of content of the web page displayed by the portable touch control device of FIG. 4, at a bottom area.

FIG. 7 is a schematic view of a fourth part of content of the web page displayed by the portable touch control device of FIG. 4, at a jump area.

### DETAILED DESCRIPTION

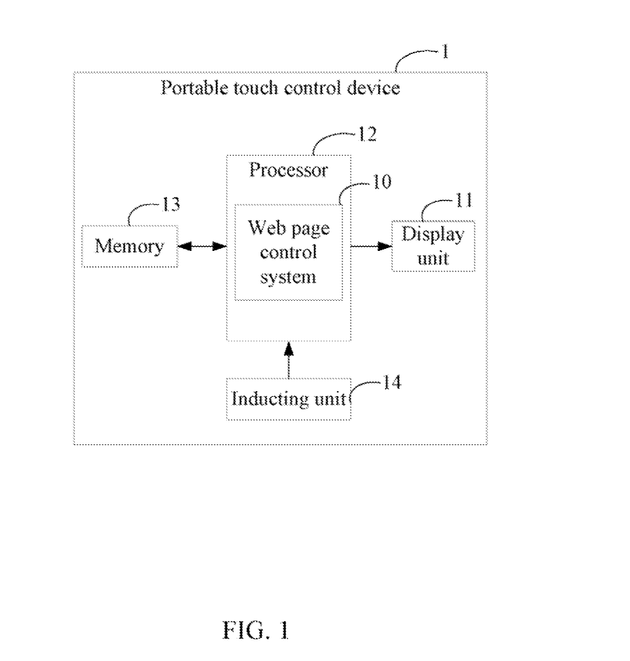

FIG. 1 is a block diagram of a portable touch control device including a web page control system in accordance with an exemplary embodiment. The web page control system 10 is applied on the portable touch control device 1. The portable touch control device 1 includes a display unit 11, a processor 12, a memory 13, and an inducting unit 14.

The display unit 11 displays a web page containing content. The content of the web page may be words, images, and/or news, for example. The processor 12 controls the portable touch control device 1 to work and runs the web page control system 10. The memory 13 stores data. The inducting unit 14 generates a control signal in response to a touch operation from a user, for example, a sliding operation up or down on the web page. In the embodiment, the display unit 11 and the inducting unit 14 constitute a touch screen.

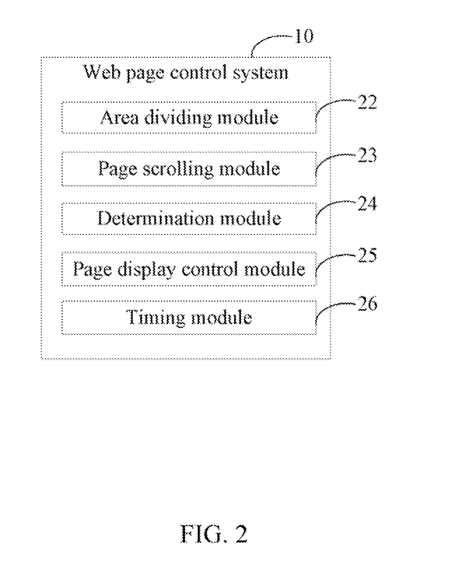

As shown in FIG. 2, the web page control system 10 includes an area dividing module 22, a page scrolling module 23, a determination module 24, a page display control module 25, and a timing module 26 which are collection of software instructions.

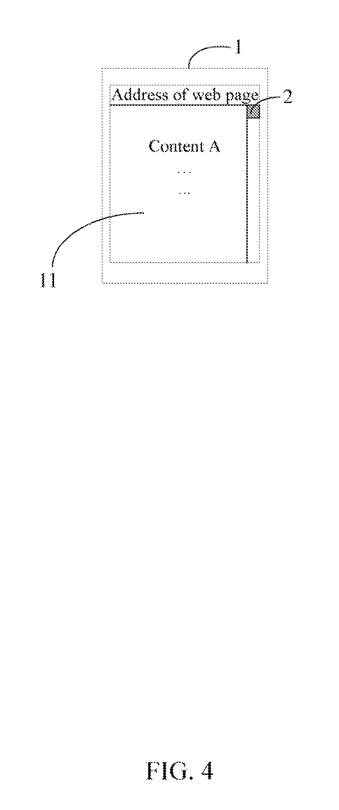

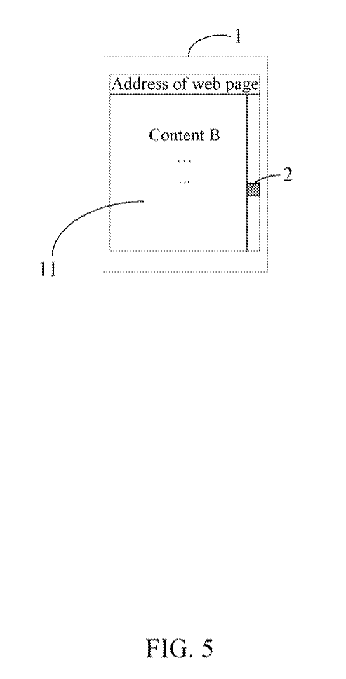

When the user wants to browse a web page, the portable touch control device 1 accesses the web page according to an address of the web page input by the user, and the page display control module 25 controls the display unit 11 to display the web page. The web page often contains much content which would consume great time to scroll the web page down to the bottom thereof. As shown in FIGS. 4-7, the display unit 11 displays an address and content of the web page. The display unit 11 may display different content of the web page in response to user input from operating a scroll bar 2. As shown in FIG. 4, when the scroll bar 2 is slid to the top of the display unit 11 in response to a first input, the display unit 11 displays content A of the web page. As shown in FIG. 5, when the scroll bar 2 is slid under the middle of the display unit 11 in response to a second input, the display unit 11 displays content B of the web page. In the embodiment, the content A is different from the content B.

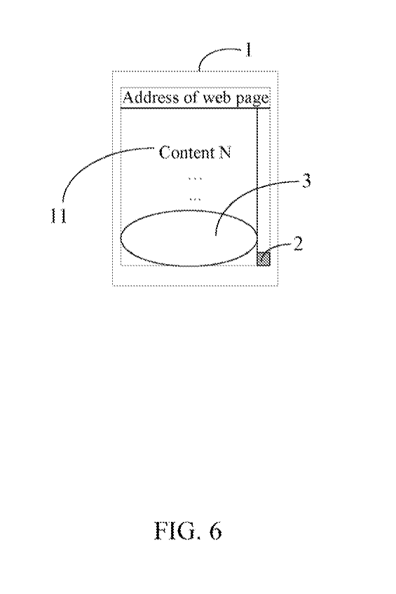

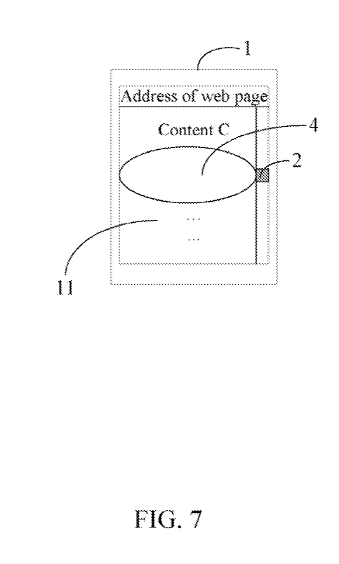

When the portable touch control device 1 displays a web page, the area dividing module 22 divides the content of the web page into a number of areas including a bottom area 3 in FIG. 6 and a jump area 4 in FIG. 7. The bottom area 3 is positioned at the bottom of the web page and contains the ending of the web page. For example, when the scroll bar 2 is slid to the bottom of the display unit 11 in response to a third input, content associated with the bottom area 3 is displayed in FIG. 6. The jump area 4 is positioned at a preset position of the web page and displays content of the web page to be regarded as key which contains important information of the web page. For example, the preset position may be on the top of the web page, or in the middle of the web page. As shown in FIG. 7, the jump area 4 is positioned in the middle of the web page, when the scroll bar 2 is slid to the middle of the display unit 11 in response to a fourth input, content associated with the jump area 4 is displayed in FIG. 7.

The page scrolling module 23 scrolls the web page in response to a first touch operation on the inducting unit 14. For example, the page scrolling module 23 scrolls down the web page in response to the first touch operation. The determination module 24 determines whether or not the web page has been scrolled to the bottom area 3. When the web page has been scrolled to the bottom area 3 in FIG. 6, the page display control module 25 performs a jump function and controls the web page to jump to the jump area 4 in FIG. 7. When the web page is not scrolled to the bottom area in FIG. 5, the page scrolling module 23 scrolls down the web page and the page display control module 25 displays the content at the current location in the web page to which the scrolling has brought the viewer, in accordance with the first touch operation, such as content B in FIG. 5.

In another embodiment, when the web page has been scrolled to the bottom area 3, the page display control module 25 displays content of the bottom area of the web page, such as content N in FIG. 6, and the timing module 26 starts measuring time. The determination module 24 determines whether or not a second touch operation is received on the web page within a preset time period. When a second touch operation is not received on the web page within a preset time period, the page display control module 25 performs the jump function and controls the web page to jump to the jump area 4. When a second touch operation is received on the web page within a preset time period, the page display control module 25 maintains the display of the bottom area of the web page. The second touch operation may be a click operation on the display unit 11, or a touch operation on the inducting unit 14.

For example, if the user wants to continue the display of the bottom area of the web page when the web page is scrolled to the bottom area, the user clicks the web page on the display unit 11; and if the user does not operate the web page within the preset time period, the page display control module 25 controls the web page to jump to the jump area.

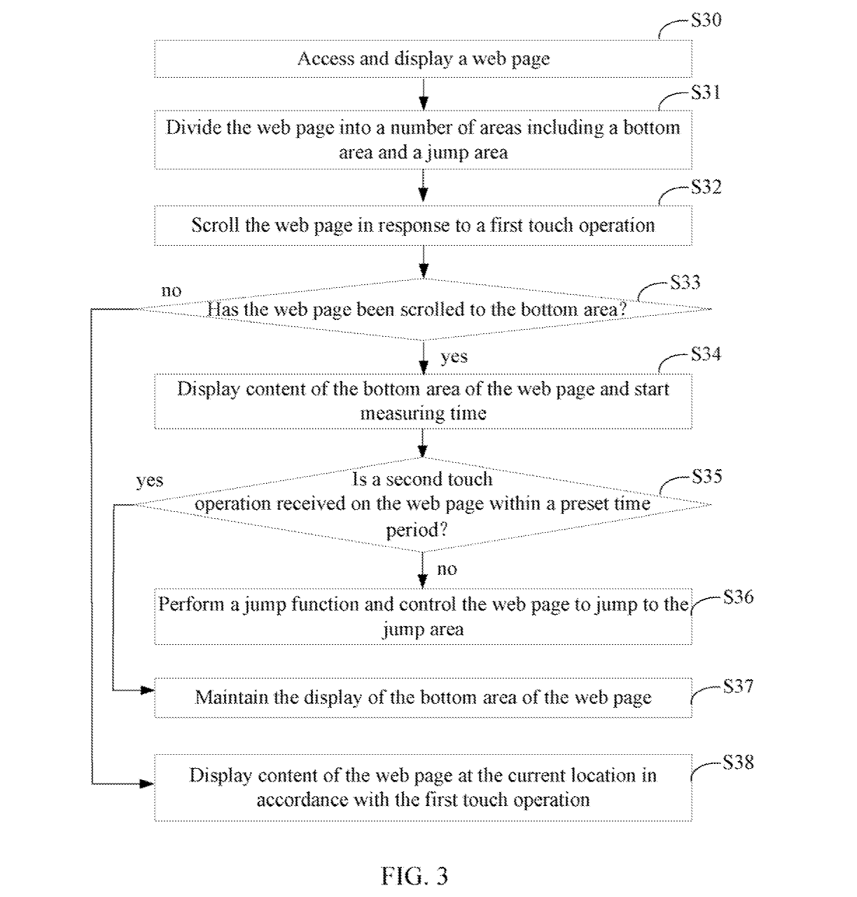

FIG. 3 is a flowchart of web page control method adapted for the web page control system of FIG. 1.

In step S30, the portable touch control device 1 accesses a web page in response to user input, and the page display control module 25 controls the display unit 11 to display the web page. In step S31, the area dividing module 22 divides the web page into a number of areas including a bottom area and a jump area.

In step S32, the page scrolling module 23 scrolls the web page in response to a first touch operation on the inducting unit 14. In step S33, the determination module 24 determines whether or not the web page has been scrolled to the bottom area 3. In step S38, when the web page is not scrolled to the bottom area 3, the page display control module 25 displays content of the web page at the current location in accordance with the first touch operation.

In step S34, when the web page has been scrolled to the bottom area 3, the page display control module 25 displays content of the bottom area 3 of the web page and the timing module 26 starts measuring time. In step S35, the determination module 24 determines whether or not a second touch operation is received on the web page within a preset time period. In step S36, if a second touch operation is not received on the web page within a preset time period, the page display control module 25 performs the jump function and controls the web page to jump to the jump area 4. In step S37, if a second touch operation is received on the web page within a preset time period, the page display control module 25 maintains the display of the bottom area 3 of the web page.

In another embodiment, when the web page is scrolled to the bottom area 3, the page display control module 25 performs an automatic jump function and controls the web page to jump to the jump area 4.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A web page control system, wherein the web page control system is applied on a portable touch control device, the system comprising:
one or more processors; and
a plurality of modules to be executed by the one or more processors, the modules comprising:
an area dividing module to divide content of a web page into a plurality of areas comprising a bottom area and a jump area when the portable touch control device displays the web page;
a page scrolling module to scroll the web page in response to a touch operation from a user;
a determination module to determine whether or not the web page has been scrolled to the bottom area; and
a page display control module to perform a jump function and control the web page to jump to the jump area when the web page has been scrolled to the bottom area.

2. The web page control system as recited in claim 1, wherein the bottom area is positioned at the bottom of the web page and contains the ending of the web page, and the jump area is positioned at a preset position of the web page and is configured to display key content of the web page.

3. The web page control system as recited in claim 2, wherein the preset position is on the top of the web page or in the middle of the web page.

4. The web page control system as recited in claim 1, wherein when the web page is not scrolled to the bottom area, the page display control module is configured to display content of the web page found at the current scrolled location in the web page in accordance with the touch operation.

5. A web page control method for a portable touch control device, the method comprising:
dividing a web page into a plurality of areas comprising a bottom area and a jump area when the portable touch control device displays the web page;
scrolling the web page in response to a first touch operation from a user;
determining whether or not the web page has been scrolled to the bottom area;
displaying content of the bottom area of the web page and starting to measure time when the web page has been scrolled to the bottom area;
determining whether or not a second touch operation is received on the web page within a preset time period; and
performing the jump function and controlling the web page to jump to the jump area when a second touch operation is not received on the web page within a preset time period.

6. The web page control method as recited in claim 5, wherein the bottom area is positioned at the bottom of the web page and contains the ending of the web page, and the jump area is positioned at a preset position of the web page and is configured to display key content of the web page.

7. The web page control method as recited in claim 6, wherein the preset position is on the top of the web page or in the middle of the web page.

8. The web page control method as recited in claim 5, further comprising:
displaying content of the web page found at the current scrolled location in the web page in accordance with the first touch operation when the web page is not scrolled to the bottom area.

9. The web page control method as recited in claim 5, further comprising:
maintaining the display of the bottom area of the web page when a second touch operation is received on the web page within a preset time period.

10. A web page control system, wherein the web page control system is applied on a portable touch control device, the system comprising:
one or more processors; and
a plurality of modules to be executed by the one or more processors, the modules comprising:
an area dividing module to divide content of a web page into a plurality of areas comprising a bottom area and a jump area when the portable touch control device displays the web page;
a page scrolling module to scroll the web page in response to a first touch operation from a user;
a determination module to determine whether or not the web page has been scrolled to the bottom area;
a page display control module to display content of the bottom area of the web page when the web page has been scrolled to the bottom area; and
a timing module to start to measure time when the web page has been scrolled to the bottom area, the determination module to determine whether or not a second touch operation is received on the web page within a preset time period, and when a second touch operation is not received on the web page within a preset time period, the page display control module to perform the jump function and control the web page to jump to the jump area.

11. The web page control system as recited in claim 10, wherein the bottom area is positioned at the bottom of the web page, and the jump area is positioned at a preset position of the web page and is configured to display key content of the web page.

12. The web page control system as recited in claim 11, wherein the preset position is on the top of the web page or in the middle of the web page.

13. The web page control system as recited in claim 10, wherein when the web page is not scrolled to the bottom area, the page display control module is configured to display corresponding content of the web page in accordance with the first touch operation.

14. The web page control system as recited in claim 10, wherein when a second touch operation is received on the web page within a preset time period, the page display control module is further configured to maintain the display of the bottom area of the web page.
